(19) United States
(12) Patent Application Publication
(10) Pub. No.: US 2012/0304419 A1
(43) Pub. Date: Dec. 6, 2012

(54) APPARATUS FOR LIMITING PIVOTAL ROTATION ANGLE

(75) Inventors: CHIEN CHENG MAI, NEW TAIPEI CITY (TW); WAY HAN DAI, NEW TAIPEI CITY (TW); CHIEN NAN TSAI, NEW TAIPEI CITY (TW)

(73) Assignee: FIRST DOME CORPORATION, NEW TAIPEI CITY (TW)

(21) Appl. No.: 13/118,675

(22) Filed: May 31, 2011

(51) Int. Cl. E05D 11/06

(52) U.S. Cl. 16/374

(57) ABSTRACT

A pivotal rotation angle limiting apparatus includes a supporting seat, a pivot shaft and a linking element. The supporting seat includes a shaft hole, an axially-extended opening connected to the shaft hole and a first connecting portion. The pivot shaft includes a second connecting portion projected from the shaft hole of the supporting seat. The linking element includes a pivot portion and a slide-guided portion, wherein the pivot portion is engaged to the first connecting portion of the supporting seat, the slide-guided portion is engaged to the second connecting portion of the pivot shaft and has a length less than a diameter of the pivot shaft, and the second connecting portion of the pivot shaft is moved along the slide-guided portion and stopped by ends of the slide-guided portion when the pivot shaft is rotated, so that the pivot shaft is limited to pivot within a constant angle.

### BACKGROUND OF THE INVENTION

1. Field of the Invention

The present invention relates to an apparatus for limiting pivotal rotation angle, and in particular relates to a simple and low-cost, firmly assembled pivotal shaft structure of lesser shaking, for limiting pivotal rotation angle.

2. Description of the Related Art

As shown in FIGS. 1 and 2, a conventional pivotal shaft structure provided with pivotal rotation angle limitation mainly includes a base 4 and a shaft 5. The base 4, capable of being connected to a body of an electronic device (e.g., laptop), includes one end provided with a bent supporting portion 41. A round axial hole 42 is formed on the supporting portion 41 of the base 4, and at least one protruded stop portion 43 is disposed next to the axial hole 42. The shaft 5 is provided with at least one a flat cutting surface at the circumference thereof. An outer thread 53 and a connecting portion 52 linked with a stopper 51 are respectively provided on two ends of the shaft 5. The connecting portion 52 of the shaft 5 is utilized to connect to a component (e.g., monitor) of the electric device needed for pivoting. When the shaft 5 passes through the axial hole 42 of the base 4, a limit element 54, an elastic element (e.g., spring) 55, a slip-stop washer 56 and a nut 57 are sequentially engaged to the shaft 5. The limit element 54 is synchronically and pivotally rotated with the shaft 5, including an indentation 541 partially formed at the circumference thereof and utilized to receive the protruded stop portion 43 of the base 4. The slip-stop washer 56 is synchronically and pivotally rotated with the shaft 5, providing a better frictional performance. The shaft 5 is elastically abutted by the elastic element 55 to compressively combine with the base 4 when the nut 57 is screwed on the outer thread 53 of the shaft 5. In the operation process, two ends of the indentation 541 of the limit element 54 are blocked by the stop portion 43 formed on the supporting portion 41 of the base 4 when the limit element 54 is synchronically and pivotally rotated with the shaft 5, thereby limiting the rotation angle of the shaft 5.

However, the contact areas of between the shaft 5 and the base 4 are limited to the inner of the axial hole 42 and the side surfaces of the stopper 51 and the supporting portion 41 i.e., the assembly structure of the shaft 5 and the base 4 is short of larger contact areas and unstable. Accordingly, the elastic element 55 shall provide a sufficient elastic force to press the limit element 54 incorporating with the stopper 51 to clamp the supporting portion 41 therebetween, to reduce or prevent shaking or loosening of the shaft 5 when rotating. Because the stableness of the assembly structure of the shaft 5 and the base 4 is proportional to the elasticity exerted by the elastic element 55, an excessive elastic compression of the elastic element 55 results in the increase of the applying force and inconvenience in the operation process, serious wearing on each component (particularly referred to the limit element 54) and regular loosening of the components. It is thus required to constantly tighten the nut 57, and the chance of the impairment and malfunction of the components is relatively increased. Furthermore, the conventional pivotal shaft structure has a diverse profile, several different components to be assembled and complicated and difficult in assembling process. Thus, the production cost of the conventional pivotal shaft structure is increased and competitiveness thereof is relatively lowered.

In view of the above problems, the invention provides an apparatus for limiting pivotal rotation angle.

### BRIEF SUMMARY OF THE INVENTION

The main purpose of the invention provides a pivotal rotation angle limiting apparatus with a simple structure and convenient assembling methods.

The another purpose of the invention provides a pivotal rotation angle limiting apparatus with a larger contact area between a supporting seat and a pivot shaft, to assure the stableness of assembly structure and prevent shaking or loosening in operation process.

To attain the purposes and functions above, the invention provides an apparatus for limiting pivotal rotation angle, including a supporting seat, a pivot shaft and a linking element. The supporting seat includes a shaft hole and a first connecting portion outwardly disposed next to the shaft hole. The pivot shaft, at least partially entered into the shaft hole of the supporting seat, includes an end provided with a second connecting portion outwardly projected from the shaft hole of the supporting seat. The linking element includes two opposite ends respectively provided with a pivot portion and a slide-guided portion, wherein the pivot portion is engaged to the first connecting portion of the supporting seat, the slide-guided portion is engaged to the second connecting portion of the pivot shaft and has a length less than a diameter of the pivot shaft, and the second connecting portion of the pivot shaft is slidably moved along the slide-guided portion of the linking element and stopped by ends of the slide-guided portion of the linking element when the pivot shaft is rotated, so that the pivot shaft is limited to reciprocally pivot within a constant angle.

The invention provides another apparatus for limiting pivotal rotation angle, including a supporting seat, a pivot shaft and a linking element. The supporting seat includes a shaft hole and a first connecting portion outwardly disposed next to the shaft hole. The pivot shaft, at least partially entered into the shaft hole of the supporting seat, includes an end provided with a second connecting portion outwardly projected from the shaft hole of the supporting seat. The linking element includes two opposite ends respectively provided with a pivot portion and a slide-guided portion, wherein the pivot portion is engaged to the second connecting portion of the pivot shaft, the slide-guided portion is engaged to the first connecting portion of the supporting seat and has a length less than a diameter of the pivot shaft, and the linking element is pivotally rotated by the second connecting portion of the pivot shaft and the first connecting portion of the supporting seat is slidably moved along the slide-guided portion of the linking element and stopped by ends of the slide-guided portion of the linking element when the pivot shaft is rotated, so that the pivot shaft is limited to reciprocally pivot within a constant angle.

According to the structures above, the supporting seat further includes a shaft-sleeve portion provided with the shaft hole and an axially-extended opening connected to the shaft hole, so that the shaft-sleeve portion is provided with an elasticity to jacket the pivot shaft.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is an exploded view of a conventional pivotal shaft structure provided with pivotal rotation angle limitation;

FIG. 2 is a schematic assembly view of the pivotal shaft structure of FIG. 1;

FIG. 3 is a structural exploded view of a first embodiment of the invention;

FIG. 4 is a whole external assembly view of the first embodiment of the invention;

FIG. 5 shows a schematic motion view of the first embodiment of the invention;

FIG. 6 shows another schematic motion view of the first embodiment of the invention;

FIG. 7 shows still another schematic motion view of the first embodiment of the invention;

FIG. 8 is a structural exploded view of a second embodiment of the invention;

FIG. 9 is a whole external assembly view of the second embodiment of the invention;

FIG. 10 shows a schematic motion view of the second embodiment of the invention;

FIG. 11 shows another schematic motion view of the second embodiment of the invention;

FIG. 12 shows still another schematic motion view of the second embodiment of the invention;

FIG. 13 is a structural exploded view of a third embodiment of the invention;

FIG. 14 is a whole external assembly view of the third embodiment of the invention;

FIG. 15 shows a schematic motion view of the third embodiment of the invention;

FIG. 16 shows another schematic motion view of the third embodiment of the invention;

FIG. 17 shows still another schematic motion view of the third embodiment of the invention;

FIG. 18 is a structural exploded view of a fourth embodiment of the invention;

FIG. 19 is a whole external assembly view of the fourth embodiment of the invention;

FIG. 20 shows a schematic motion view of the fourth embodiment of the invention;

FIG. 21 shows another schematic motion view of the fourth embodiment of the invention; and

FIG. 22 shows still another schematic motion view of the fourth embodiment of the invention.

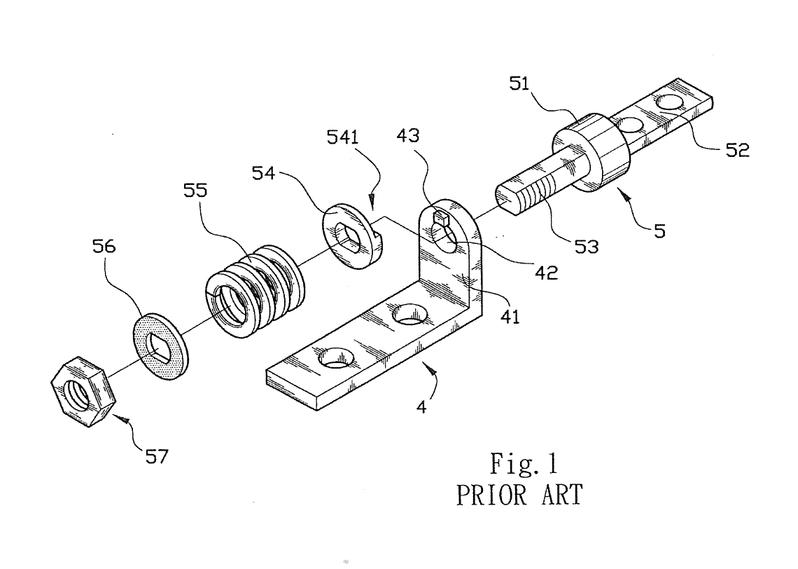

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

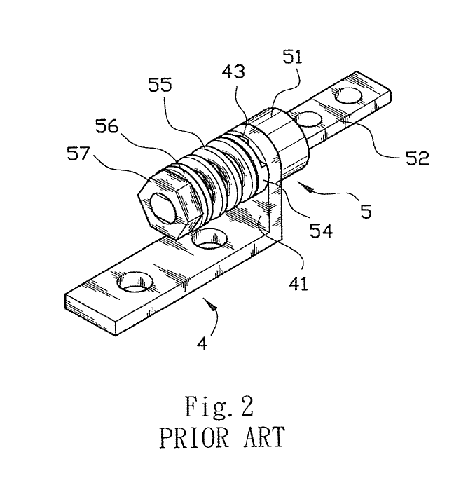

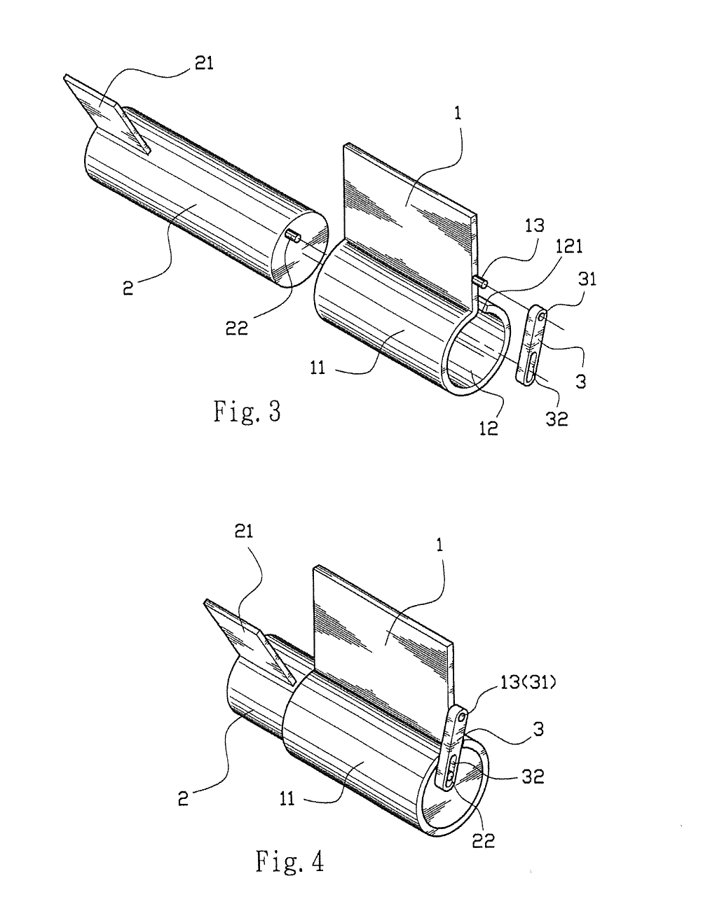

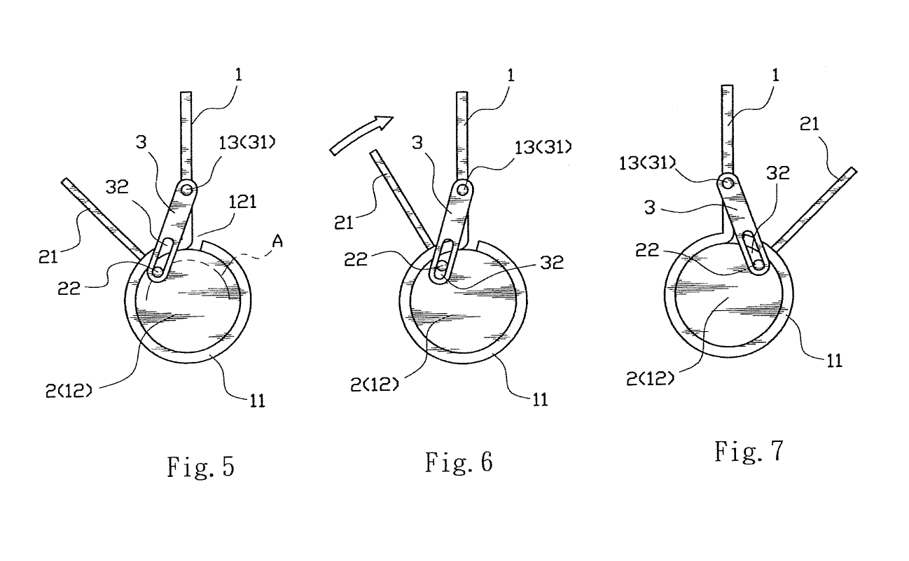

Referring to FIGS. 3 and 4, it can be observed that the structure of a pivotal rotation angle limiting apparatus of a first embodiment of the invention mainly comprises a supporting seat 1, a pivot shaft 2 and a linking element 3. The supporting seat 1, capable of being fixed to a body of an electronic device (e.g., laptop), comprises a shaft-sleeve portion 11 and a first connecting portion 13 outwardly disposed next to the shaft-sleeve portion 11. In this embodiment, the first connecting portion 13 can be a protrusion or a protruded post. The shaft-sleeve portion 11 is provided with the shaft hole 12 and an axially extended and outwardly connected opening 121, wherein the opening 121 is disposed on and connected to the shaft hole 12. Therefore, in the supporting seat 1, an effect of elastic sleeve is circumferentially formed around the shaft hole 12 of the shaft-sleeve portion 11. The pivot shaft 2 comprises two ends, one of which is provided with a joint portion 21, and the other end of which is utilized to enter into the shaft hole 12 of the supporting seat 1 and provided with a second connecting portion 22, wherein the second connecting portion 22 of the pivot shaft 2 is outwardly projected from the shaft hole 12 of the supporting seat 1 when the pivot shaft 2 is entered into the shaft hole 12 of the supporting seat 1. In this embodiment, the second connecting portion 22 can be a protrusion or a protruded post. The linking element 3 comprises two opposite ends respectively provided with a pivot portion 31 and a slide-guided portion 32. In this embodiment, the pivot portion 31 can be a pivot-shaft hole, and the slide-guided portion 32 can be a long slotted hole. The pivot portion 31 (pivot-shaft hole) of the linking element 3 is pivotally jacketed to the first connecting portion 13 (protruded post) of the supporting seat 1, and the slide-guided portion 32 (long slotted hole) of the linking element 3 is engaged to the second connecting portion 22 (protruded post) of the pivot shaft 2. The slide-guided portion 32 of the linking element 3 has a length less than a diameter of the pivot shaft 2, intended to allow the end provided with the slide-guided portion 32 thereof moving within an area of a semicircle “A” (shown in FIG. 5) where is located at one side of an edge of the shaft hole 12 to be approached by the first connecting portion 13.

Referring to FIGS. 5 to 7, it can be observed that, in the operation process of the structure of the first embodiment, the second connecting portion 22 (protruded post) of the pivot shaft 2 is slidably moved along the slide-guided portion 32 (long slotted hole) of the linking element 3 and stopped by ends of the slide-guided portion 32 of the linking element 3 when the pivot shaft 2 is rotated, so that the second connecting portion 22 of the pivot shaft 2 is pivotally rotated within the area of the semicircle “A” where is approached by the first connecting portion 13 of the supporting seat 1. Due to the first connecting portion 13 (protruded post) of the supporting seat 1 to be served as an axis of the linking element 3, the displacement of the second connecting portion 22 (protruded post) of the pivot shaft 2 is taken by the slide-guided portion 32 (long slotted hole) of the linking element 3 shown in FIG. 6 and the second connecting portion 22 (protruded post) of the pivot shaft 2 is stopped by ends of the slide-guided portion 32 of the linking element 3 (shown in FIGS. 5 and 7) when the pivot shaft 2 is rotated, so that the pivot shaft 2 is limited to reciprocally pivot within a constant angle.

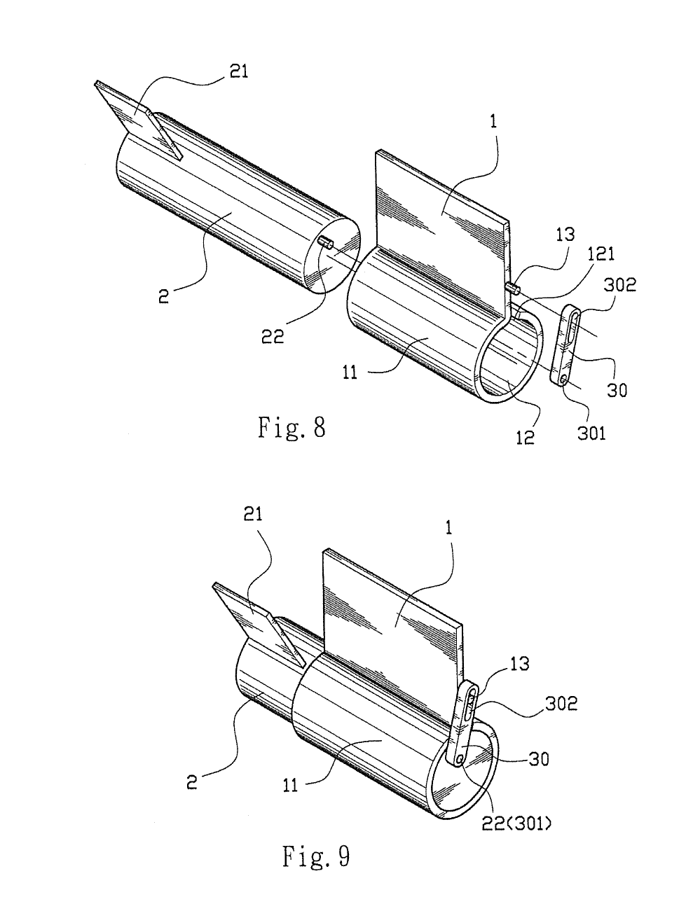

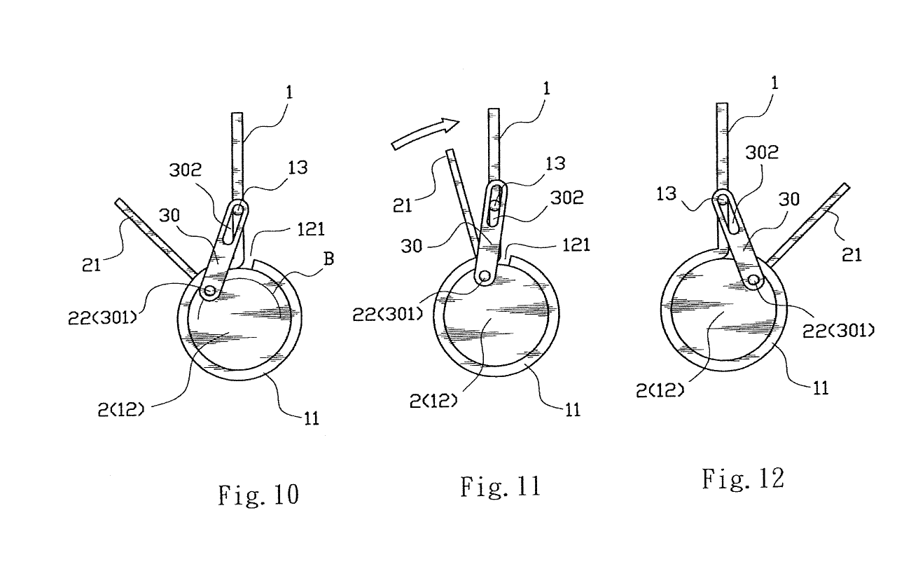

Referring to FIGS. 8 and 9, it can be observed that the structure of a pivotal rotation angle limiting apparatus of a second embodiment of the invention mainly comprises the supporting seat 1 and the pivot shaft 2 of the first embodiment, and a linking element 3. The assembly process of the supporting seat 1 and the pivot shaft 2 is the same as the first embodiment. The structure of the second embodiment differs from that of the first embodiment in that the linking element 3 comprises a pivot portion 301 and a slide-guided portion 302, wherein the pivot portion 301 is pivotally jacketed to the second connecting portion 22 of the pivot shaft 2, and the slide-guided portion 302 is engaged to the first connecting portion 13 of the supporting seat 1 and has a length less than a diameter of the pivot shaft 2. The linking element 30 has a length intended to allow the end provided with the pivot portion 301 thereof moving within an area of a semicircle “B” (shown in FIG. 10) where is located at one side of an edge of the shaft hole 12 to be approached by the first connecting portion 13.

Referring to FIGS. 10 to 12, it can be observed that, in the operation process of the structure of the second embodiment, the first connecting portion 13 of the supporting seat 1 is slidably moved along the slide-guided portion 302 of the linking element 3 (shown in FIG. 11) and stopped by ends of the slide-guided portion 302 of the linking element 3 (shown in FIGS. 10 and 12) when the pivot shaft 2 is rotated, so that the second connecting portion 22 of the pivot shaft 2 is pivotally rotated within the area of the semicircle “B” where is approached by the first connecting portion 13 of the supporting seat 1 and the pivot shaft 2 is limited to reciprocally pivot within a constant angle.

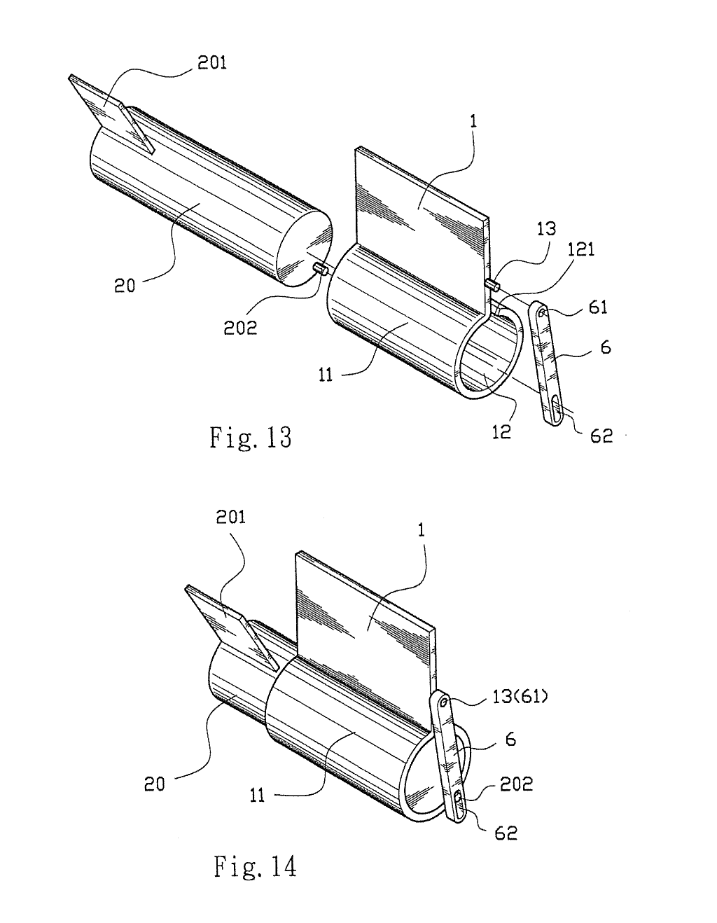

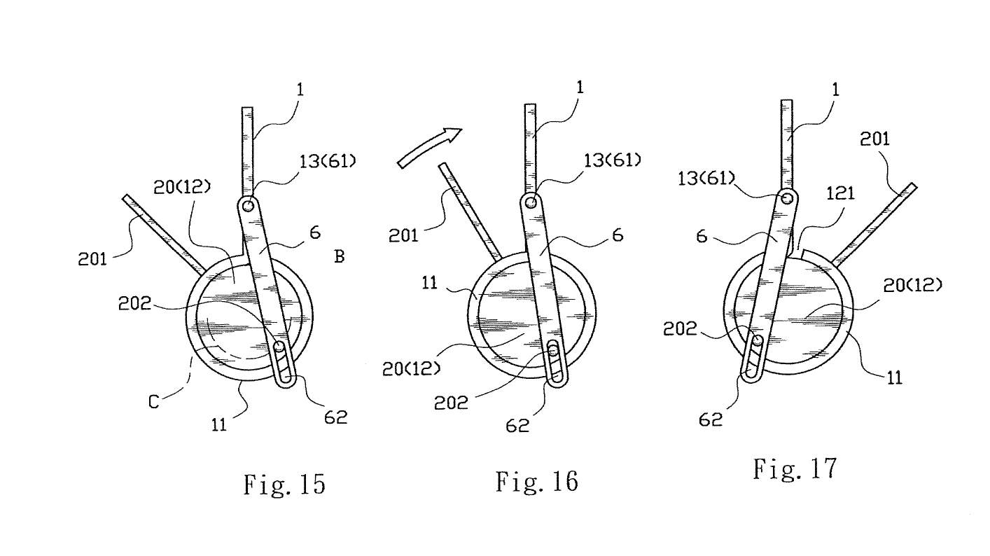

Referring to FIGS. 13 and 14, it can be obviously observed that the structure of a pivotal rotation angle limiting apparatus of a third embodiment of the invention mainly comprises a pivot shaft 20, a linking element 6, and the supporting seat 1 of the first embodiment. The pivot shaft 20 comprises a joint portion 201 and a second connecting portion 202. It can be observed that the location of the second connecting portion 202 of the pivot shaft 20 in the third embodiment is different from that of the second connecting portion 22 of the pivot shaft 2 in the first embodiment. The linking element 6 comprises two opposite ends respectively provided with a pivot portion 61 and a slide-guided portion 62. In this embodiment, the pivot portion 61 can be a pivot-shaft hole, and the slide-guided portion 62 can be a long slotted hole. The pivot portion 61 (pivot-shaft hole) of the linking element 6 is pivotally jacketed to the first connecting portion 13 of the supporting seat 1, and the slide-guided portion 62 (long slotted hole) of the linking element 6 is engaged to the second connecting portion 202 of the pivot shaft 20. The slide-guided portion 62 of the linking element 6 has a length less than a diameter of the pivot shaft 20, and the linking element 6 has a length intended to allow the end provided with the slide-guided portion 62 thereof moving within an area of a semicircle “C” (shown in FIG. 15) where is located at one side of an edge of the shaft hole 12 to be distant from the first connecting portion 13.

Referring to FIGS. 15 to 17, it can be observed that, in the operation process of the structure of the third embodiment, the second connecting portion 202 (protruded post) of the pivot shaft 20 is slidably moved along the slide-guided portion 62 (long slotted hole) of the linking element 6 and stopped by ends of the slide-guided portion 62 of the linking element 6 when the pivot shaft 20 is rotated, so that the second connecting portion 202 of the pivot shaft 20 is pivotally rotated within the area of the semicircle “C” where is distant from the first connecting portion 13 of the supporting seat 1. Due to the first connecting portion 13 of the supporting seat 1 to be served as an axis of the linking element 6, the displacement of the second connecting portion 202 of the pivot shaft 20 is taken by the slide-guided portion 62 of the linking element 6 (shown in FIG. 16) and the second connecting portion 202 (protruded post) of the pivot shaft 20 is stopped by ends of the slide-guided portion 62 of the linking element 6 (shown in FIGS. 15 and 17) when the pivot shaft 20 is rotated, so that the pivot shaft 20 is limited to reciprocally pivot within a constant angle.

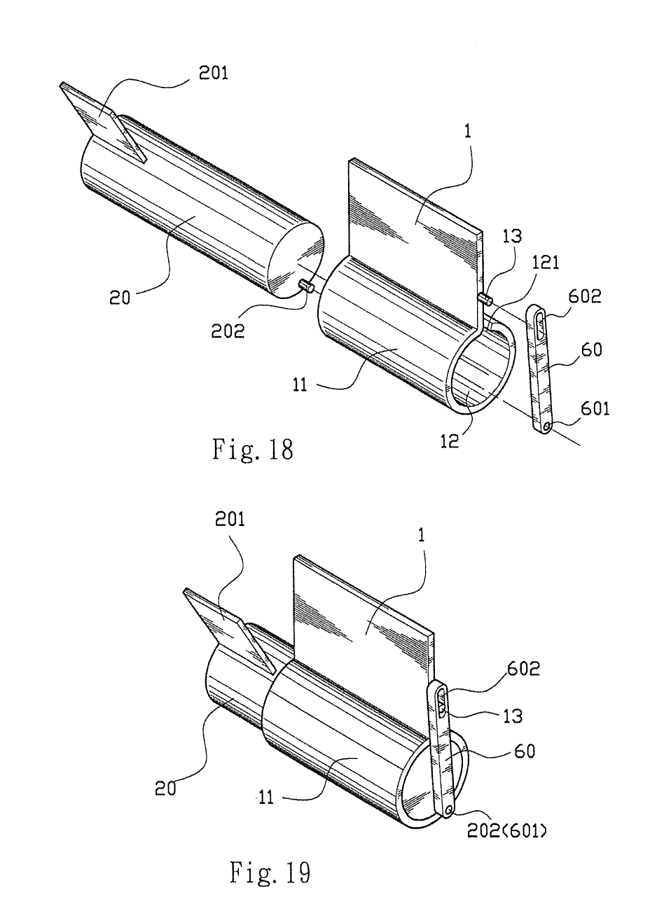

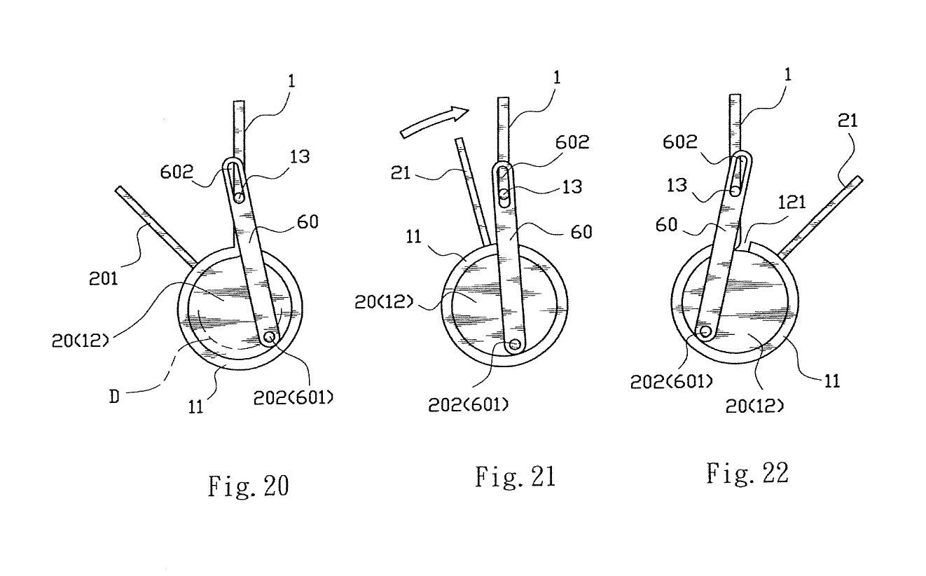

Referring to FIGS. 18 and 19, it can be observed that the structure of a pivotal rotation angle limiting apparatus of a fourth embodiment of the invention mainly comprises a pivot shaft 20, a linking element 60, and the supporting seat 1 of the first embodiment. The pivot shaft 20 comprises a joint portion 201 and a second connecting portion 202. It can be observed that the location of the second connecting portion 202 of the pivot shaft 20 in the fourth embodiment is different from that of the second connecting portion 22 of the pivot shaft 2 in the first embodiment. The linking element 60 comprises two opposite ends respectively provided with a pivot portion 601 and a slide-guided portion 602. In this embodiment, the pivot portion 601 can be a pivot-shaft hole, and the slide-guided portion 602 can be a long slotted hole. The pivot portion 601 of the linking element 60 is pivotally jacketed to the second connecting portion 202 of the pivot shaft 20, and the slide-guided portion 602 of the linking element 60 is engaged to the first connecting portion 13 of the supporting seat 1. The slide-guided portion 602 of the linking element 60 has a length less than a diameter of the pivot shaft 20, and the linking element 60 has a length intended to allow the end provided with the slide-guided portion 602 thereof moving within an area of a semicircle “D” (shown in FIG. 20) where is located at one side of an edge of the shaft hole 12 to be distant from the first connecting portion 13.

Referring to FIGS. 20 to 22, it can be observed that, in the operation process of the structure of the fourth embodiment, the first connecting portion 13 of the supporting seat 1 is slidably moved along the slide-guided portion 602 of the linking element 60 (shown in FIG. 21) and stopped by ends of the slide-guided portion 602 of the linking element 60 (shown in FIGS. 20 and 22) when the pivot shaft 20 is rotated, so that the second connecting portion 22 of the pivot shaft 20 is pivotally rotated within the area of the semicircle “D” where is distant from by the first connecting portion 13 of the supporting seat 1 and the pivot shaft 20 is limited to reciprocally pivot within a constant angle.

In conclusion, the invention can surely provide the pivotal rotation angle limiting apparatus with a simple and low-cost, firmly assembled structure of lesser shaking, for limiting pivotal rotation angle. While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus for limiting pivotal rotation angle, at least comprising:
a supporting seat, comprising a shaft hole and a first connecting portion outwardly disposed next to the shaft hole;
a pivot shaft at least partially entered into the shaft hole of the supporting seat, comprising an end provided with a second connecting portion; and
a linking element, comprising two opposite ends respectively provided with a pivot portion and a slide-guided portion, the pivot portion being engaged to the first connecting portion of the supporting seat, the slide-guided portion being engaged to the second connecting portion of the pivot shaft and having a length less than a diameter of the pivot shaft, the second connecting portion of the pivot shaft being slidably moved along the slide-guided portion of the linking element and stopped by ends of the slide-guided portion of the linking element when the pivot shaft is rotated, so that the pivot shaft is limited to reciprocally pivot within a constant angle.

2. The apparatus for limiting pivotal rotation angle as claimed in claim 1, wherein the linking element has a length intended to allow the end provided with the slide-guided portion thereof moving within an area of a semicircle where is located at one side of an edge of the shaft hole to be approached by the first connecting portion.

3. The apparatus for limiting pivotal rotation angle as claimed in claim 1, wherein the linking element has a length intended to allow the end provided with the slide-guided portion thereof moving within an area of a semicircle where is located at one side of an edge of the shaft hole to be distant from the first connecting portion.

4. The apparatus for limiting pivotal rotation angle as claimed in claim 1, wherein the second connecting portion of the pivot shaft is outwardly projected from the shaft hole of the supporting seat.

5. The apparatus for limiting pivotal rotation angle as claimed in claim 2, wherein the second connecting portion of the pivot shaft is outwardly projected from the shaft hole of the supporting seat.

6. The apparatus for limiting pivotal rotation angle as claimed in claim 3, wherein the second connecting portion of the pivot shaft is outwardly projected from the shaft hole of the supporting seat.

7. An apparatus for limiting pivotal rotation angle, at least comprising:
a supporting seat, comprising a shaft hole and a first connecting portion outwardly disposed next to the shaft hole;
a pivot shaft at least partially entered into the shaft hole of the supporting seat, comprising an end provided with a second connecting portion; and
a linking element, comprising two opposite ends respectively provided with a pivot portion and a slide-guided portion, the pivot portion being engaged to the second connecting portion of the pivot shaft, the slide-guided portion being engaged to the first connecting portion of the supporting seat and having a length less than a diameter of the pivot shaft, the linking element being pivotally rotated by the second connecting portion of the pivot shaft and the first connecting portion of the supporting seat being slidably moved along the slide-guided portion of the linking element and stopped by ends of the slide-guided portion of the linking element when the pivot shaft is rotated, so that the pivot shaft is limited to reciprocally pivot within a constant angle.

8. The apparatus for limiting pivotal rotation angle as claimed in claim 7, wherein the linking element has a length intended to allow the end provided with the pivot portion thereof moving within an area of a semicircle where is located at one side of an edge of the shaft hole to be approached by the first connecting portion.

9. The apparatus for limiting pivotal rotation angle as claimed in claim 7, wherein the linking element has a length intended to allow the end provided with the pivot portion thereof moving within an area of a semicircle where is located at one side of an edge of the shaft hole to be distant from the first connecting portion.

10. The apparatus for limiting pivotal rotation angle as claimed in claim 7, wherein the second connecting portion of the pivot shaft is outwardly projected from the shaft hole of the supporting seat.

11. The apparatus for limiting pivotal rotation angle as claimed in claim 8, wherein the second connecting portion of the pivot shaft is outwardly projected from the shaft hole of the supporting seat.

12. The apparatus for limiting pivotal rotation angle as claimed in claim 9, wherein the second connecting portion of the pivot shaft is outwardly projected from the shaft hole of the supporting seat.

13. The apparatus for limiting pivotal rotation angle as claimed in claim 1, wherein the supporting seat further comprises a shaft-sleeve portion provided with the shaft hole and an axially-extended opening connected to the shaft hole, so that the shaft-sleeve portion is provided with an elasticity to jacket the pivot shaft.

14. The apparatus for limiting pivotal rotation angle as claimed in claim 2, wherein the supporting seat further comprises a shaft-sleeve portion provided with the shaft hole and an axially-extended opening connected to the shaft hole, so that the shaft-sleeve portion is provided with an elasticity to jacket the pivot shaft.

15. The apparatus for limiting pivotal rotation angle as claimed in claim 3, wherein the supporting seat further comprises a shaft-sleeve portion provided with the shaft hole and an axially-extended opening connected to the shaft hole, so that the shaft-sleeve portion is provided with an elasticity to jacket the pivot shaft.

16. The apparatus for limiting pivotal rotation angle as claimed in claim 4, wherein the supporting seat further comprises a shaft-sleeve portion provided with the shaft hole and an axially-extended opening connected to the shaft hole, so that the shaft-sleeve portion is provided with an elasticity to jacket the pivot shaft.

17. The apparatus for limiting pivotal rotation angle as claimed in claim 7, wherein the supporting seat further comprises a shaft-sleeve portion provided with the shaft hole and an axially-extended opening connected to the shaft hole, so that the shaft-sleeve portion is provided with an elasticity to jacket the pivot shaft.

18. The apparatus for limiting pivotal rotation angle as claimed in claim 8, wherein the supporting seat further comprises a shaft-sleeve portion provided with the shaft hole and an axially-extended opening connected to the shaft hole, so that the shaft-sleeve portion is provided with an elasticity to jacket the pivot shaft.

19. The apparatus for limiting pivotal rotation angle as claimed in claim 9, wherein the supporting seat further comprises a shaft-sleeve portion provided with the shaft hole and an axially-extended opening connected to the shaft hole, so that the shaft-sleeve portion is provided with an elasticity to jacket the pivot shaft.

20. The apparatus for limiting pivotal rotation angle as claimed in claim 10, wherein the supporting seat further comprises a shaft-sleeve portion provided with the shaft hole and an axially-extended opening connected to the shaft hole, so that the shaft-sleeve portion is provided with an elasticity to jacket the pivot shaft.

21. The apparatus for limiting pivotal rotation angle as claimed in claim 13, wherein the pivot portion of the linking element is a pivot-shaft hole, and the first connecting portion of the supporting seat and the second connecting portion of the pivot shaft are protruded posts capable of being engaged by the pivot-shaft hole.

22. The apparatus for limiting pivotal rotation angle as claimed in claim 14, wherein the pivot portion of the linking element is a pivot-shaft hole, and the first connecting portion of the supporting seat and the second connecting portion of the pivot shaft are protruded posts capable of being engaged by the pivot-shaft hole.

23. The apparatus for limiting pivotal rotation angle as claimed in claim 15, wherein the pivot portion of the linking element is a pivot-shaft hole, and the first connecting portion of the supporting seat and the second connecting portion of the pivot shaft are protruded posts capable of being engaged by the pivot-shaft hole.

24. The apparatus for limiting pivotal rotation angle as claimed in claim 17, wherein the pivot portion of the linking element is a pivot-shaft hole, and the first connecting portion of the supporting seat and the second connecting portion of the pivot shaft are protruded posts capable of being engaged by the pivot-shaft hole.

25. The apparatus for limiting pivotal rotation angle as claimed in claim 18, wherein the pivot portion of the linking element is a pivot-shaft hole, and the first connecting portion of the supporting seat and the second connecting portion of the pivot shaft are protruded posts capable of being engaged by the pivot-shaft hole.

26. The apparatus for limiting pivotal rotation angle as claimed in claim 19, wherein the pivot portion of the linking element is a pivot-shaft hole, and the first connecting portion of the supporting seat and the second connecting portion of the pivot shaft are protruded posts capable of being engaged by the pivot-shaft hole.

27. The apparatus for limiting pivotal rotation angle as claimed in claim 13, wherein the slide-guided portion of the linking element is a long slotted hole, and the first connecting portion of the supporting seat and the second connecting portion of the pivot shaft are protruded posts capable of inserting into the long slotted hole.

28. The apparatus for limiting pivotal rotation angle as claimed in claim 14, wherein the slide-guided portion of the linking element is a long slotted hole, and the first connecting portion of the supporting seat and the second connecting portion of the pivot shaft are protruded posts capable of inserting into the long slotted hole.

29. The apparatus for limiting pivotal rotation angle as claimed in claim 15, wherein the slide-guided portion of the linking element is a long slotted hole, and the first connecting portion of the supporting seat and the second connecting portion of the pivot shaft are protruded posts capable of inserting into the long slotted hole.

30. The apparatus for limiting pivotal rotation angle as claimed in claim 17, wherein the slide-guided portion of the linking element is a long slotted hole, and the first connecting portion of the supporting seat and the second connecting portion of the pivot shaft are protruded posts capable of inserting into the long slotted hole.

31. The apparatus for limiting pivotal rotation angle as claimed in claim 18, wherein the slide-guided portion of the linking element is a long slotted hole, and the first connecting portion of the supporting seat and the second connecting portion of the pivot shaft are protruded posts capable of inserting into the long slotted hole.

32. The apparatus for limiting pivotal rotation angle as claimed in claim 19, wherein the slide-guided portion of the linking element is a long slotted hole, and the first connecting portion of the supporting seat and the second connecting portion of the pivot shaft are protruded posts capable of inserting into the long slotted hole.

33. The apparatus for limiting pivotal rotation angle as claimed in claim 1, wherein the pivot portion of the linking element is a pivot-shaft hole, and the first connecting portion of the supporting seat and the second connecting portion of the pivot shaft are protruded posts capable of being engaged by the pivot-shaft hole.

34. The apparatus for limiting pivotal rotation angle as claimed in claim 2, wherein the pivot portion of the linking element is a pivot-shaft hole, and the first connecting portion of the supporting seat and the second connecting portion of the pivot shaft are protruded posts capable of being engaged by the pivot-shaft hole.

35. The apparatus for limiting pivotal rotation angle as claimed in claim 3, wherein the pivot portion of the linking element is a pivot-shaft hole, and the first connecting portion of the supporting seat and the second connecting portion of the pivot shaft are protruded posts capable of being engaged by the pivot-shaft hole.

36. The apparatus for limiting pivotal rotation angle as claimed in claim 4, wherein the pivot portion of the linking element is a pivot-shaft hole, and the first connecting portion of the supporting seat and the second connecting portion of the pivot shaft are protruded posts capable of being engaged by the pivot-shaft hole.

37. The apparatus for limiting pivotal rotation angle as claimed in claim 7, wherein the pivot portion of the linking element is a pivot-shaft hole, and the first connecting portion of the supporting seat and the second connecting portion of the pivot shaft are protruded posts capable of being engaged by the pivot-shaft hole.

38. The apparatus for limiting pivotal rotation angle as claimed in claim 8, wherein the pivot portion of the linking element is a pivot-shaft hole, and the first connecting portion of the supporting seat and the second connecting portion of the pivot shaft are protruded posts capable of being engaged by the pivot-shaft hole.

39. The apparatus for limiting pivotal rotation angle as claimed in claim 9, wherein the pivot portion of the linking element is a pivot-shaft hole, and the first connecting portion of the supporting seat and the second connecting portion of the pivot shaft are protruded posts capable of being engaged by the pivot-shaft hole.

40. The apparatus for limiting pivotal rotation angle as claimed in claim 10, wherein the pivot portion of the linking element is a pivot-shaft hole, and the first connecting portion of the supporting seat and the second connecting portion of the pivot shaft are protruded posts capable of being engaged by the pivot-shaft hole.

41. The apparatus for limiting pivotal rotation angle as claimed in claim 1, wherein the slide-guided portion of the linking element is a long slotted hole, and the first connecting portion of the supporting seat and the second connecting portion of the pivot shaft are protruded posts capable of inserting into the long slotted hole.

42. The apparatus for limiting pivotal rotation angle as claimed in claim 5, wherein the slide-guided portion of the linking element is a long slotted hole, and the first connecting portion of the supporting seat and the second connecting portion of the pivot shaft are protruded posts capable of inserting into the long slotted hole.
